(19) United States
(12) Patent Application Publication
(10) Pub. No.: US 2011/0265019 A1
(43) Pub. Date: Oct. 27, 2011

(54) SOCIAL GROUPS SYSTEM AND METHOD

(75) Inventors: Mehmet Ecevit, Istanbul (TR); Tunga Sanalp, Istanbul (TR); Erdem Usul, Istanbul (TR)

(73) Assignee: OyunStudyosu Ltd. Sti., Bostanci Istanbul (TR)

(21) Appl. No.: 13/092,731

(22) Filed: Apr. 22, 2011

Related U.S. Application Data
(60) Provisional application No. 61/327,093, filed on Apr. 22, 2010.
(60) Provisional application No. 61/330,145, filed on Apr. 30, 2010.

(51) Int. Cl. G06F 3/01; G06F 15/16

(52) U.S. Cl. 715/757

(57) ABSTRACT

A system and method for the creation of a virtual world on top of an online community are provided. The system for the creation of a virtual world on top of an online community may be known as SROUPS. SROUPS creates or provides a tool for online community users to create virtual worlds on top of any online community.

### PRIORITY CLAIMS/RELATED APPLICATIONS

This patent application claims the benefit under 35 USC 119(e) to U.S. Provisional Patent Application Ser. No. 61/327,093 filed on Apr. 22, 2010 and titled “Social Groups System and Method” and to U.S. Provisional Patent Application Ser. No. 61/330,145 filed on Apr. 30, 2010 and titled “Social Groups System and Method”, the entirety of both of which are incorporated herein by reference.

### FIELD

The disclosure relates generally to a system and method for creating virtual worlds and in particular to a system and method for the creation of a virtual world on top of an online community.

### BACKGROUND

An Online Community is a virtual community that exists online, whose members enable its existence. An Online Community can take the form of an information system where anyone can post content such as a bulletin board system, Weblogs, photos, videos, applications, RSS feeds, etc.

Online Communities consists of a plurality of users and/or objects where users are defined as online or offline users who have joined this community. Objects are defined as information in form of any kind of data, goods, tables, etc taking part in the group or imported externally.

A Virtual World is a genre of Online Community that often takes the form of a computer-based simulated environment, through which users can interact with one another and use and create objects. Virtual Worlds are intended for its users to inhabit and interact in interactive virtual environments where the users take the form of avatars visible to others graphically. These virtual environments and avatars are usually depicted as textual or graphical representations of several dimensions (such as 2D, 2.5D, 3D, etc) or a combination of both, although other forms are possible (auditory and touch sensations for example). The environment can be formed as a city, a building, a room, a shop, a theatre, a planet, a space ship, a village for rock music users, an virtual application store for iPhone users, etc, and a combination of all of these.

Internet users form groups or communities with each other to discuss and share ideas or data on any subject. Whereas when we consider the user interaction it can be realized that most of the activities happen in an offline way with limited interaction between the users. There is also very limited interaction between the objects and the users in real-time. On top of this, even if it is online and real-time, any interaction would be text or voice based. The utmost personal interaction would be video based whereas it has to be peer to peer, which prevents the users from being able to interact with a group of people based in different locations.

The disclosure addresses these questions and creates a Virtual World for a group or community where the actions and the interactions between the users and the objects are taken into an interactive platform.

### BRIEF DESCRIPTION OF THE DRAWINGS

FIG. 1 illustrates an example of an implementation of a system for the creation of a virtual world on top of an online community;

FIG. 2 illustrates an example of a user interface in the virtual world system to create an avatar for a user; and

FIGS. 3-7 illustrate examples of the user interface in the virtual world system that permits avatars of different user to interact with each other.

### DETAILED DESCRIPTION OF ONE OR MORE EMBODIMENTS

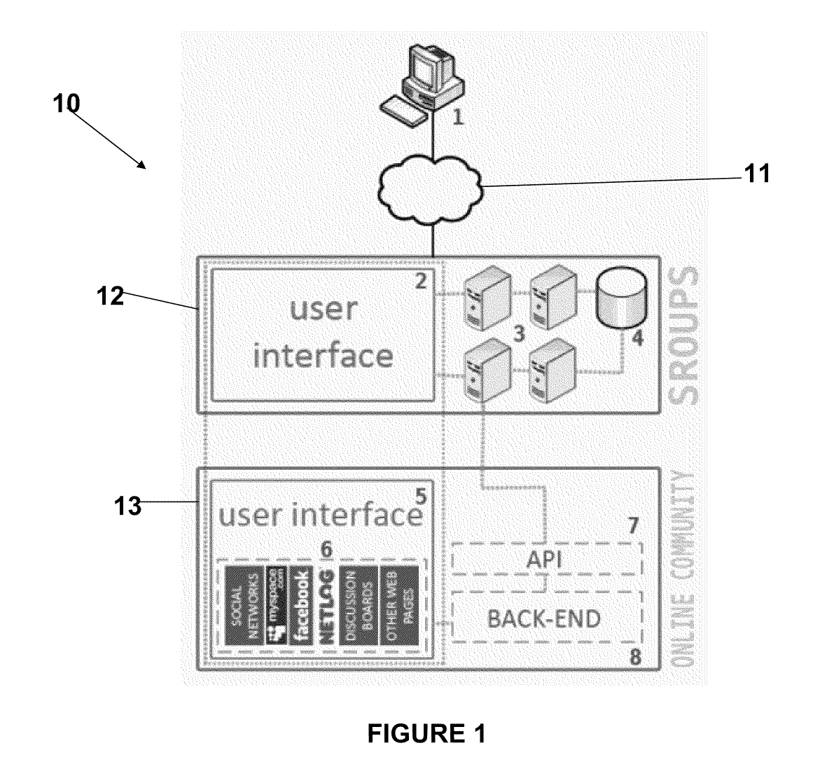

A system and method for creating virtual worlds and in particular to a system and method for the creation of a virtual world on top of an online community are described. In one implementation, the system is illustrated as a client/server web-based architecture (as shown in FIG. 1), but the system and method can be implemented using other architectures and elements that are within the scope of the teachings of the disclosure.

An “Online Community” includes an online group or community of users—a single user to many users—on any Internet or mobile enabled platform. “Online Community Users” includes any user—visitors, members, non-members, owners, moderators, having online or offline status—related to an Online Community. A “Virtual World” may include any computer simulated environment. The system and method for the creation of a virtual world on top of an online community may be known as “SROUPS” and the system creates, provides a tool for online community users to create, virtual worlds on top of any online community.

In one embodiment, SROUPS creates or provides the tools to create Virtual Worlds on top of Online Communities, including but not limited to Facebook groups, Facebook fan pages, MySpace artist pages, discussion boards, forums on any web site, etc. When an Online Community User wants to create a virtual world for any Online Community, the user can do it through a web site, a toolbar, a task bar or by directly installing and/or running the appropriate SROUPS application—this can be done automatically by enabling the existing SROUPS application or any other platform related application or it might already exist in the related platform, like an iPhone application.

The concept of the each Virtual World created using SROUPS can be defined by the user, which might also be done by using predefined templates that may be provided by SROUPS, or through automatic context detection in which, by analyzing the group conversation for example, SROUPS can generate the “right” Virtual World.

In the automatic context detection, online communities include data related to its scope such as videos, forums, pictures, tags, text messages, etc that form the context of the community. The system can implement processes for the detection of this context. When a Community User creates SROUPS, SRUOUPS automatically scans the data from the Online Community and analyzes this data in a smart way to detect the key information that builds its context. For example, a Facebook groups/fan pages have category system which is the key info for the context detection and the process can just grab the related word out of this category and hence automatically detect the context. As another example, web forums have unique text-based titles for every discussion forum. These titles can be easily analyzed by the process (which may be a computer implemented algorithm) by matching the related words to a predefined list and hence automatically detecting the context.

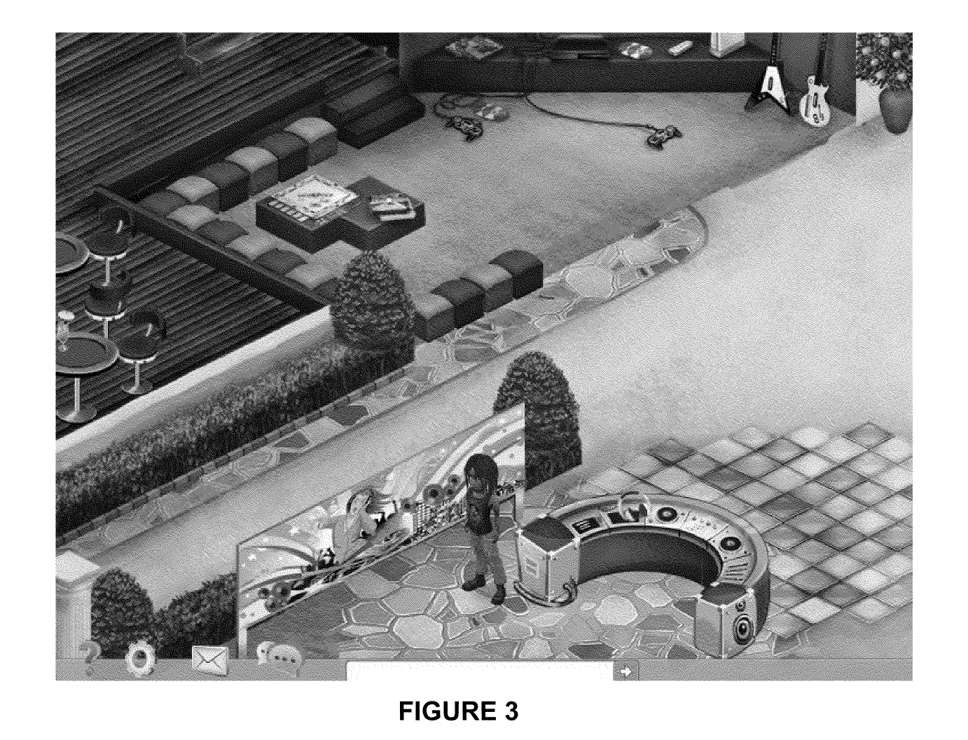

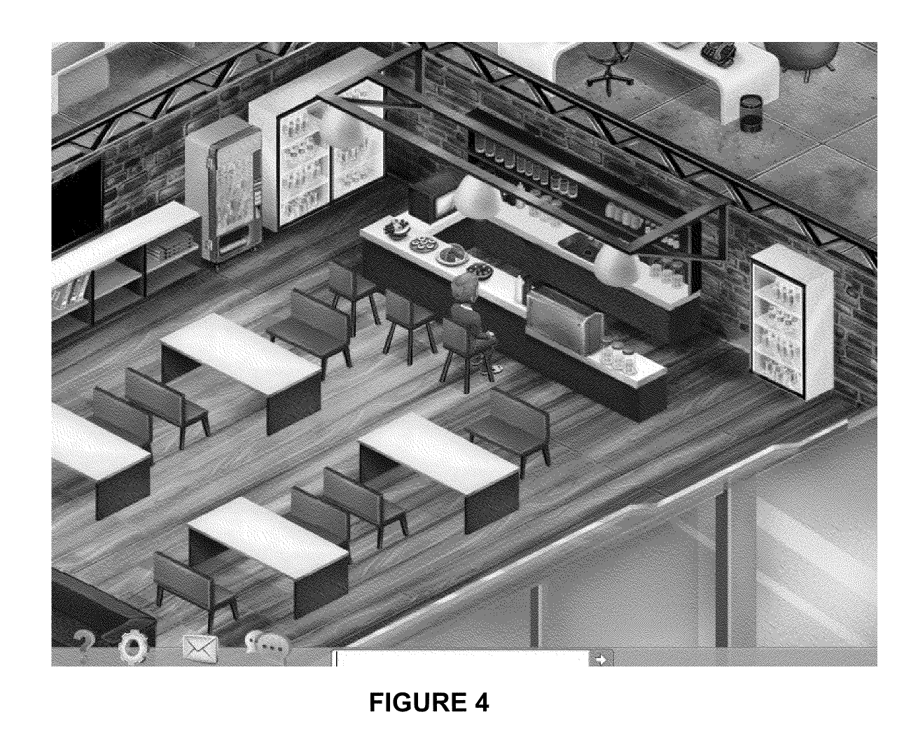

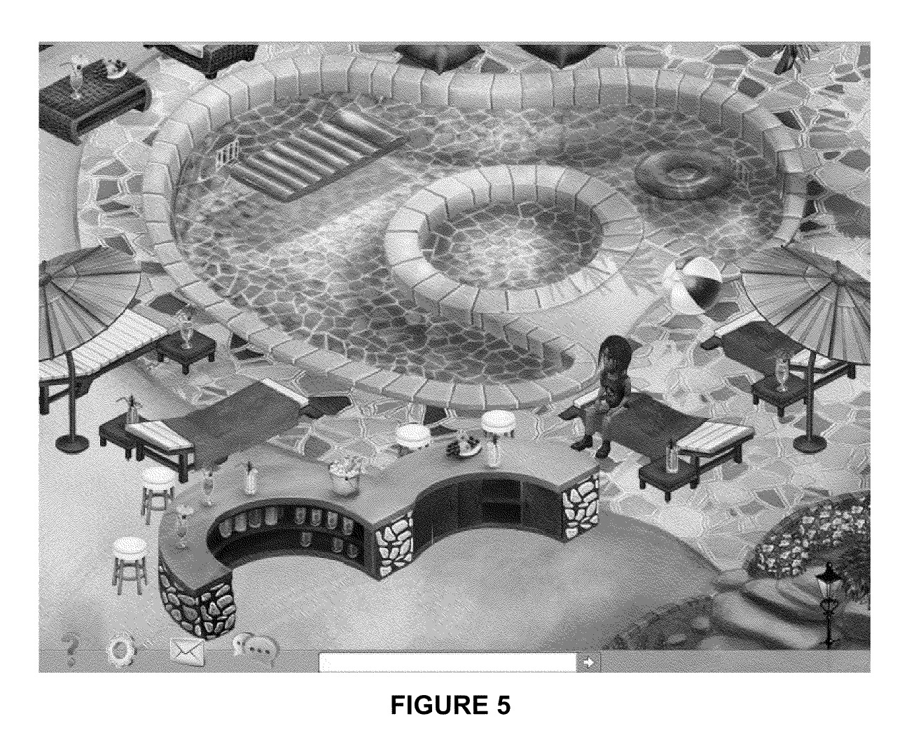

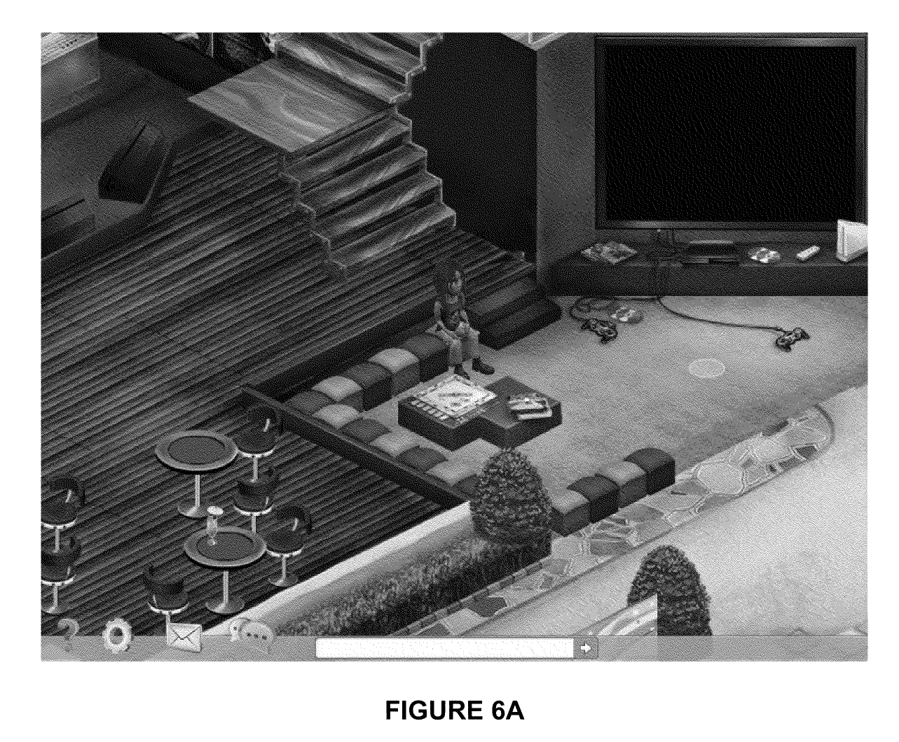

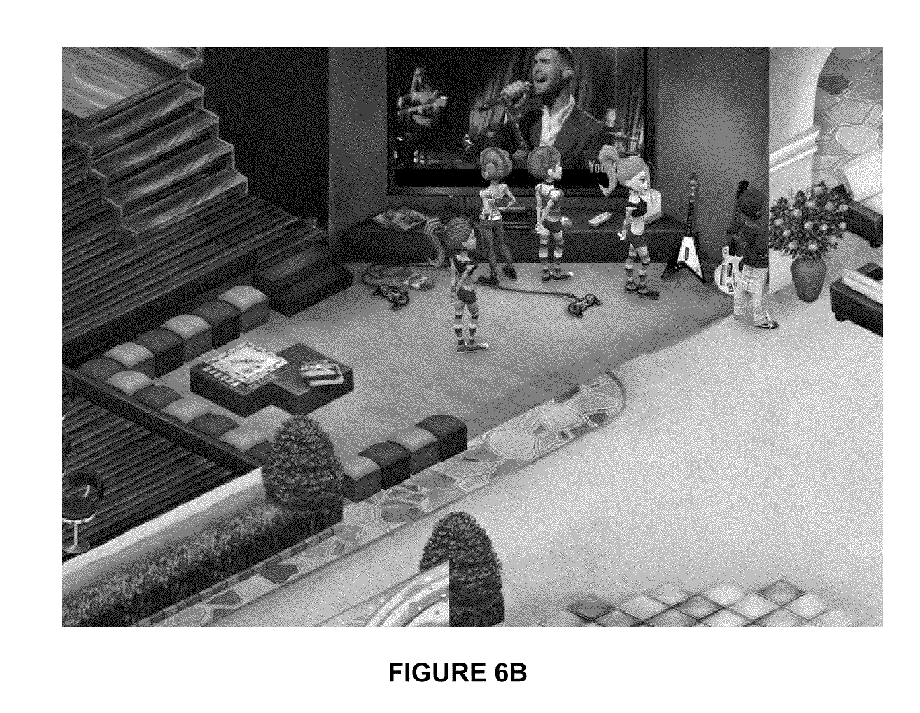

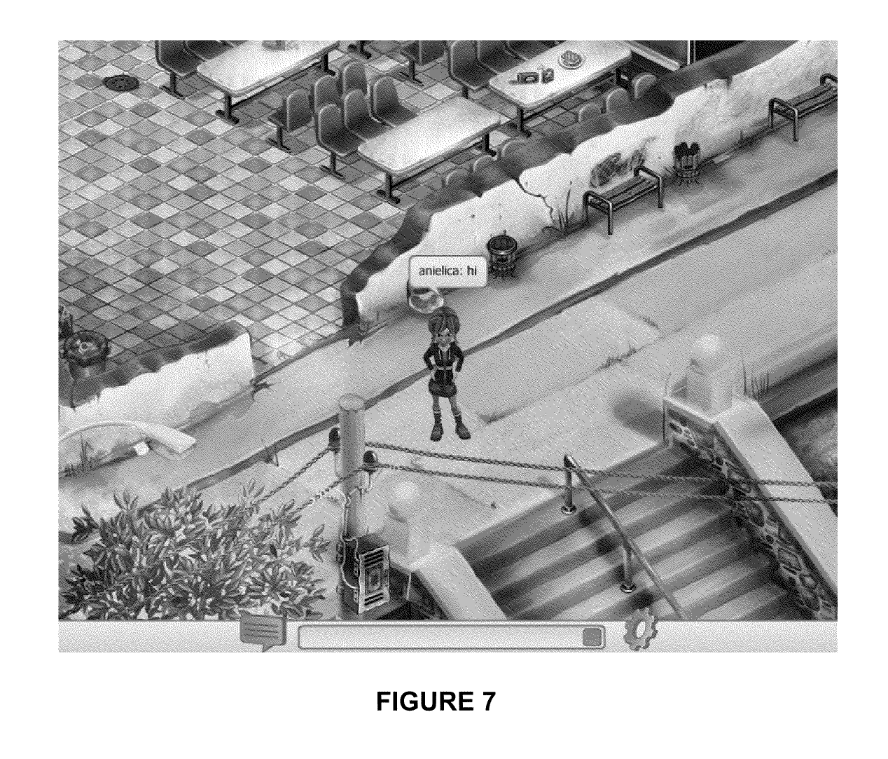

Each virtual world is a computer simulated graphical environment where smaller places come together to make a bigger world. Each virtual world can be created in any form and based around any concept; like a university campus for a school group, a lab for a scientific group, a hospital environment for a group related to health, a gym and stadium for a group related to sports, a visual application store for iPhone users, a rave village for music fans made up of different scenes, set of islands for travel sites, a cosmic system for UFO and space fans with several planets and space ships, etc. The possible different instantiations of a virtual world are almost endless and SROUPS can be used to generate any virtual world as shown, for example, in the user interface examples shown in FIGS. 3-7.

The SROUPS Virtual World contains installable applications called “Gadgets” where users interact with different services of the online community or service provider. A gadget is an computer program that runs inside the SROUPS. The gadgets are developed using the sroups development libraries provided by SROUPS system. A gadget can be a game, a video player, a tax calculator, a forecast application, etc. The data source of the gadget is an online community (not necessarily the sroups container community) or a service provider. The SROUPS system communicates with the data source via a certain interface namely OpenSocial API's which is a set of application programming interfaces (API's) for web-based social network applications (Number 8 in FIG. 1). The gadgets can only use external data fetched from a data source using the OpenSocial specification. In other words, SROUPS itself does not store any data.

Once the SROUPS Virtual World is created, users can log-in to the environment, either manually or by automatic redirection by the parent application or site. The creator of the SROUPS can define user rights so that, for example, entry to the virtual world or to certain levels of the virtual world can be restricted or anyone can be allowed to enter the virtual world. The creator of the SROUPS can manage the user roles and rights. A role defines the user rights for interacting with certain functionalities of virtual world called resources. There are at least 5 types of user roles which are administrators, moderators, srousers, guests and developers. The administrators are the top level super user that can access most of the resources. Moderators are allowed to configure the content and manage users. Srousers are the standard users logged into the community. Guests are the anonymous users who are not logged in to the community. Developers are the gadget developers and contributes.

The following table describes the roles and authorization rights.

| | Admin- | | | | |
|---|---|---|---|---|---|
| Actions | istrators | Moderators | Srousers | Guests | Developers |
| Add/Remove | ✓ | | | | |
| gadgets | | | | | |
| Configure | ✓ | ✓ | | | |
| Gadgets | | | | | |
| View Gadgets | ✓ | ✓ | ✓ | | ✓ |
| User | ✓ | ✓ | | | |
| management* | | | | | |
| Configure | ✓ | | | | |
| SROUPS* | | | | | |
| Communication | ✓ | ✓ | ✓ | ✓ | ✓ |

User management includes banning or disabling the communicating services for a user and SROUPS Configuration includes changing the theme and graphics set.

Once a user enters the SROUPS Virtual World, the user can have a view and can interact with the avatars of other users and/or objects in this world. In addition, the user can chat and direct questions to anybody or everybody in a place and get instant answers or can discuss photos and videos together being able to modify and mark them real-time. The user can also interact with offline users, leaving them messages, tasks or objects for them to see once they become online. The user also can create objects, places, tasks, quests, goods, discussion forums, etc inside the world. It also is possible for the user to make photo or video presentations, trade and sell objects and get payments with virtual or real currency. In the virtual world, everything is multi-user and interactive which overpowers surfing web pages or following text based chat or discussion forms.

A user case example where SROUPS creates a big difference could be imagined based on a discussion forum. Think of a user posting a question to the discussion forum and waiting for an answer. The user submits the question to the pool without any interaction or idea of who is there to give an answer. It will take some time for the user to receive an answer and most of the time he would have to ask supporting questions and get answers which will last for some time, from few minutes to few weeks. Also, the user should be polling the forum frequently to check if any answer is received or not. Whereas with a virtual world created by SROUPS, the user can interact directly and in real-time with users and investigate to find the right person or people to answer his questions, sharing all ideas and visual information or presentations with them. Now, an implementation of the system for creation of virtual worlds on top of online communities is described in more detail.

FIG. 1 illustrates an example of an implementation of a system 20 for the creation of a virtual world on top of an online community. The system has one or more computing units 1 that can be used to access a SROUPS system 12 over a link 11. Each computing unit may be used by a user to set up, manage and/or interact with a virtual world that may be build on top of an online community using the system 12. Each computing unit may be a processing unit based device with memory, input/output devices, a display and connectivity (wired or wireless) to connect to and interact with the system 12 and a set of online communities 13. For example, each computing unit may be a personal computer, laptop computer, tablet device, smartphone (Apple iPhone or RIM Blackberry), cellular phone and the like. The link 11 may be the Internet, a wired link (LAN, etc.) or a wireless link (wireless digital data network, wireless cellular network, etc.).

The system 12 may have a unit 2 that generates a user interface for each user to access the site (for log-in, creation of a virtual world and interactions in the virtual world), one or more unit 3 (such as one or more server computers in one implementation) that execute computer code to implement the functions and operations of the SROUPS system that are described below in more detail and one or more stores 4, such as software or hardware databases or other storage devices, that store the various data associated with each user, each virtual world and the like.

The system 20 may also have one or more associated online communities 13 on top of which the system creates and maintains the virtual worlds. Each online community 13 may further comprise a unit 5 that generates a user interface for each user of the particular online community, an API layer 7 that the SROUPS system 12 interacts with and a backend 8 that may include one or more units (such as one or more server computers in one implementation) that execute computer code to implement the functions and operations of the online community and one or more stores, such as software or hardware databases or other storage devices, that store the various data associated with each user, the online community.

SROUPS is a super set implementation of an Online Community creating a Virtual World with the aim of socializing any group of people on the Internet or mobile in the form of a web page, web application, social networks application, mobile application, desktop application and/or console application or a combination of any of the above.

The implementation is realized by getting the data from an Online Community by any means like user input, data post and/or data transfer by set of APIs (Application Programming Interface) (See for example, API 7 shown in FIG. 1) which bind to the data sources of the community and using this data inside the Virtual World for any action or interaction between users and objects. This data may include any user or group related information including pictures, videos, log-in data, user specific personal or profile information, etc.

SROUPS, now being the Virtual World of the community, use this data to make the users and objects interact with each other. One example would be putting the latest uploaded video to the virtual TV and providing the users to watch the video altogether in the Virtual World.

SROUPS is a user interface which can be a web page, a SWF movie running on an Adobe™ Flash platform, a mobile application or a Facebook application. All these possible platforms provide the user ability to interact with the elements of the Virtual World components of SROUPS.

Implementation of the community mostly takes place on the units 3 (which may be known as data-processing servers) of the SROUPS. These units are responsible for:

Getting and Processing the data: Servers need specific data of the community to run on top of it which is the user profile information. This community user's profile information provides SROUPS to give the user a feeling that SROUPS is a part of the online community. For example, by getting the user's screen name (nickname), SROUPS process this data and can use this nickname in the Virtual World as the representation of the user's avatar.

Also servers can use other data stored in the community also which can be an uploaded picture/album/video, the topics in the discussion forums or the background image of the community's web page etc.

Gathering this data is the function of the back-end servers of SROUPS. This servers are hosted internally on the SROUPS own server network which provides high security and high availability to the community users.

Running the Virtual World: To run the Virtual World a set of server applications (being a plurality of lines of computer code executed by one or more processing units of the data processing servers, for example) can be required such as:
Chat Server: This server is an socket server which enables the multiplayer technology for the Virtual World component of SROUPS. Chat server is responsible for broadcasting the action of a user to the other users who are in the Virtual World over tcp/ip technology.
Rope Server: This server is responsible for providing a secured communication protocol between SROUPS user interface and the back end servers, such as chat server or database servers.
Dynamic Web Server: This server is responsible for serving the web pages of SROUPS if SROUPS interface takes place on web. This server uses a server-side language such as php, jsp or asp.net to serve the pages which contains dynamic data.
Static File Server: This server is responsible for serving the static files such as images, xml files, videos etc.

Even SROUPS gets the data from the community; it also needs an internal database for its own needs. This database contains specific information to run the SROUPS on top of an online community. This information is the user preferences. As SROUPS run a Virtual World, it must provide the users to express themselves in the best way such as creating avatar. Also users in the Virtual World have ability to modify the settings and modify the Virtual World in their own needs. This creates a set of data which forms the user preferences. Besides the user preferences, SROUPS also use this database to hold the Virtual World creation settings such as the background picture, Virtual World name etc.

Like SROUPS user interface, Online Communities need a user interface for interaction with the user. This user interface is widely known as web page. User navigates through the web pages by using an Internet browser.

As described above SROUPS also has a user interface, too. As shown in the figure above (2-5/FIG. 1), these two user interfaces are not independent from each other. As SROUPS intends to be a part of the community, SROUPS user interface is somehow connected to the online community's user interface. For example, if the Online Community takes place in a social network, such as Facebook or MySpace, SROUPS will be in the form of a social network application. As the user uses the social network, SROUPS will be in the same domain as the social network. So it is sure that, user will accept the application as the part of the community.

Online Community's user interface sometimes can be an implementation if the community takes place in a social network (6/FIG. 1). For example, Facebook has group and fan page implementation. Sometimes this user interface can be bulletin board (6/FIG. 1). These are kind of ready-made, ready-to-use discussion boards.

SROUPS needs some data for its goal of socializing the community. There are several ways of passing the user data to SROUPS like user input, data post and/or data transfer by set of APIs (Application Programming Interface). API is the short form of application programming interface. API is used to provide information between the closed-systems in a common way. This systems share the required data between each other in a secured and controllable way. SROUPS in here, might need and use the API in the same way. SROUPS needs user and community specific data, and the community itself has it. But to control security and control the data-flow, API is the best way for this communication.

As told above, Online Community can be in different forms on the web. So different API solutions are needed to achieve the goal of data communication. These are;

If Online Community takes place in a social network, the solution in this case is using the existing API of the social network. Many social networks provide developers a set of APIs to interact with the community. SROUPS can easily use these APIs with the help of the back-end servers.

If Online Community is a kind of bulletin board, the solution in this case is using the advantage of plug-in system of the board. Many bulletin boards provide ability to write custom plug-in which can be easily integrated into an already running board. Plug-ins are simple kind of programs which can use the functions in which they will be integrated into.

If Online Community is a web page, the solution in this case is using the SROUPS own coded server-side scripts. SROUPS has its own API for this cases. As every web page could be programmed with a different server side language, SROUPS provides required API with the appropriate server side language

Like SROUPS, Online Community also need server infrastructure to run the group. As community can be in different forms, the back-end system of it projected to be a closed system. Because any community can run on any platform, can be database dependent or not, can use jsp or asp.net technology for the server-side etc. This is the reason of why SROUPS needs an API for the data communication between the community data-systems and SROUPS data-systems. Now, examples of the user interface of the virtual world system are described in more detail.

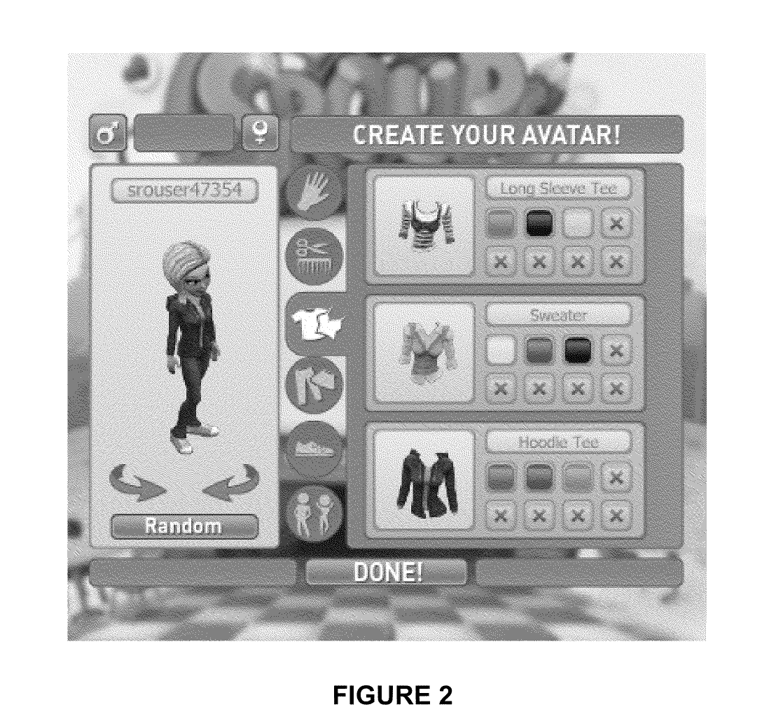

FIG. 2 illustrates an example of a user interface in the virtual world system to create an avatar for a user. The user can pick a male or female avatar, change the clothes of the avatar, the grooming of the avatar and the like using the user interface. The avatar is a electronic image that the user moves around the virtual world and interacts with other users who are also members of the particular group from the social online community. FIGS. 3-7 illustrate examples of the user interface in the virtual world system that permits avatars of different user to interact with each other.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A system for generating a virtual world on top of an online community, the system comprising:
one of more computing units;
a virtual world system connectable to each of the one or more computing units over a link;
the virtual world system having a user interface unit for generating a user interface to one of log into an existing virtual world and create a new virtual world; one or more online communities from which data is extracted from a virtual world and on top of which the virtual world is formed, one or more data processing units that extract and process the data from the one or more online communities and generate the virtual world and one or more stores that store the data associated with the virtual world system.

2. The system of claim 1, wherein each computing unit is one of a personal computer, a laptop computer, a tablet device, a smartphone and a cellular phone.

3. The system of claim 2, wherein the link is one of the Internet, a wired link and a wireless link.

4. The system of claim 1, wherein the one or more data processing units further comprises a chat unit that broadcasts an action of a user of a particular virtual world to other users in the particular virtual world, a rope unit that provides a secure communications path between the chat unit and the user interface unit, a dynamic web unit that generates a plurality of dynamic web pages to the one or more computing units and a static file unit that servers a plurality of static files to the one or more computing units.

5. The system of claim 4, wherein the chat unit is a server computer that stores a chat application that is executed by a processing unit of the server computer, the rope unit is a server computer that stores a rope application that is executed by a processing unit of the server computer, the dynamic web unit is a server computer that stores a dynamic web application that is executed by a processing unit of the server computer and the static file unit is a server computer that stores a static file application that is executed by a processing unit of the server computer.

6. The system of claim 1, wherein the virtual world system further comprises one or more application programming interfaces that allow the virtual world system to interact with and extract data from the one or more online communities.

7. A method for generating a virtual world on top of a online community using one of more computing units and a virtual world system connectable to each of the one or more computing units over a link, the method comprising:
creating, using a computer implemented system, a virtual world for a group of user of an online community;
providing, using a user interface unit of the virtual world system, a user interface of the virtual world system to log into an existing virtual world and create a new virtual world; and
providing access to the group of user of an online community to the virtual world.

8. The method of claim 7, wherein creating the virtual world further comprises extracting from the online community data and processing the data from the online community to create the virtual world.

9. The method of claim 7 further comprising broadcasting, using a chat unit of the virtual world system, an action of a user of a particular virtual world to other users in the particular virtual world.

10. The method of claim 9 further comprising establishing, using a rope unit of the virtual world system, a secure communications path between the chat unit and the user interface unit.

11. The method of claim 7 further comprising generating, using a dynamic web unit of the virtual world system, a plurality of dynamic web pages to the one or more computing units.

12. The method of claim 7 further comprising generating, using a static file unit of the virtual world system, a plurality of static files to the one or more computing units.
